(19) United States
(12) Patent Application Publication
(10) Pub. No.: US 2021/0146511 A1
(43) Pub. Date: May 20, 2021

(54) Winged screwdriver

(71) Applicant: Atticus Lee Sawatzki, Norfolk, VA (US)

(72) Inventor: Atticus Lee Sawatzki, Norfolk, VA (US)

(21) Appl. No.: 16/602,689

(22) Filed: Nov. 20, 2019

(51) Int. Cl. B25B 15/06

(52) U.S. Cl. CPC B25B 15/06

(57) ABSTRACT

This disclosure describes the invention of a winged screwdriver. Limitations of the utility of screwdrivers described prior art are discussed, including physical clearance requirements. These limitations are eliminated by the use of a winged screwdriver, which allows its user to provide sufficient torque for tightening and loosening screws with vertical clearance of as little as 2 inches. This screwdriver is assembled from two component pieces: a wingnut, and a machined piece, known as the screw-bit.

### CROSS-REFERENCE TO RELATED APPLICATIONS

None

### STATEMENT REGARDING FEDERALLY SPONSORED RESEARCH AND DEVELOPMENT

Not Applicable

### PARTIES TO A JOINT RESEARCH AGREEMENT

Not Applicable

### INCORPORATION-BY-REFERENCE

None

### BACKGROUND OF THE INVENTION

### Field of the Invention

This invention relates to a hand tool, more specifically a screwdriver. This present screwdriver is able to provide sufficient torque to a screw located in an area of limited physical clearance; for example, in spaces of less than 64 cubic inches.

### Description of the Related Art

A commonly marketed screwdriver is described in U.S. Pat. No. 2,046,837; granted Jul. 7, 1936 to Henry F. Phillips. A visual representation of prior art is given in FIG. 1 of aforementioned US patent. A screwdriver adapted for used by surgeons is described in U.S. Pat. No. 2,329,398; granted Sep. 14, 1943 to Bernard A. Duffy. In these two examples, the diameter of the screwdriver handle, acting as the lever arm, is multiplied by the user's manual force to produce torque upon the screw. U.S. Pat. No. 4,625,597; granted Dec. 2, 1986 to Adolf Cast, describes a motor-driven apparatus that can be operated by one hand only. These screwdrivers (Phillips and Duffy) are designed with significant distance between the handle-grip and the bit which engages the top of the screws. Such a design is preferred for use in locations such as electrical switchboards and the human body, so that the user's hands avoid contact with physically hazardous or messy materials. However, the present art of screwdrivers is ill-suited for limited-space applications such as tightening set screws used on ceiling fans. In such instances, screwdrivers on the market today either slip from the bit of the screw, or do not achieve an optimal perpendicular angle between screwdriver and screw head. None of the above inventions and patents is seen to describe the instant invention as claimed. Thus a winged screwdriver addressing the aforementioned problems and limitations is desired.

### BRIEF SUMMARY OF THE INVENTION

This invention allows the user to apply torque to tighten or loosen screws located in areas of limited clearance. The reduced profile of this new screwdriver requires clearance as little as 2 inches vertical from the screw head for the user to utilize this invention. Torque produced against a screw is generated by manual force upon the screw bit's attached wings, which act as a lever arm.

### BRIEF DESCRIPTION OF THE SEVERAL VIEWS OF THE DRAWING

FIG. 1—Winged Screwdriver, as assembled, in profile view. Item 1 exhibits the screw-bit, and Item 2 depicts the wingnut.

FIG. 2—Winged Screwdriver, as assembled, in end view

### DETAILED DESCRIPTION OF THE INVENTION

The invention consists a “winged screwdriver” consisting of two metal components, a wingnut and a machined screw-bit; screwed, welded or otherwise bonded together.

Production of the Screw-Bit

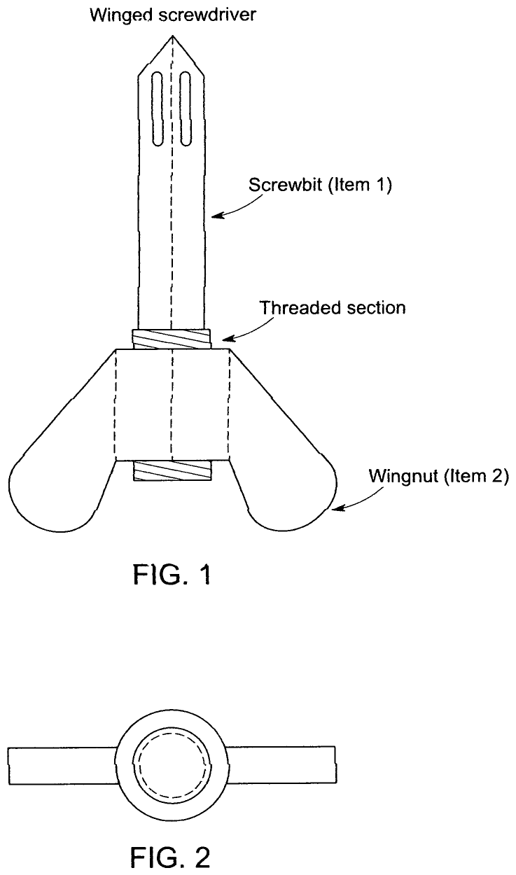

The screw-bit (FIG. 1, Item 1) is produced from a 1.5 inch length of round Stainless Steel Stock, ¼ inch diameter, polished finish.

One end of this Stock will remain at % inch diameter for a length of ½ inches. This wide end of Stock is die-cut to ¼″-28 UNF (US National Fine) series thread for a screwed length of ½ inches.

The remaining 1 inch length of this Stock is Lathe-cut to 3/16 inch diameter, polished finish

Reserve ⅜ inch at end of screw-bit to mill into a common bit profile, JIS being used in this example (Phillips #2 or flathead being two other examples)
⅛ inch at end is to be ground at 26.5 degree angle off-center as for JIS cut.
⅜ inch at end is to be gouged at 4 points, located at 90 degree angles, in a manner that the deepest width of each gouge is located ⅛ inch from end; and so that the width of gouge at the end and at ⅜ inch is symmetrical in appearance.
The intent of these gouges is to provide uniform width of angled flanks at 1/32 inch.

Wipe away metal shavings from screw-bit.

### Procurement of the Wingnut

The wingnut (FIG. 1, Item 2) is procured through commercial sources, specified as: Right-Hand Threaded Wingnut, specification ¼″-28 UNF (US National Fine) series thread, stainless steel material.

Assembly of the Winged Screwdriver

The wingnut is screwed onto the ¼ inch threaded portion of the screw-bit, with the distal end of the wings facing away from the end of screw-bit milled to JIS profile.

The wingnut will be spun until it the threaded portion protrudes at 0.20 inches from the wingnut boss.

The wingnut is then permanently affixed to the screw-bit by means such as welding, brazing, adhesive or epoxy. The completed winged screwdriver is demonstrated as (FIG. 1).

I claim:

1) An apparatus for tightening or loosening screws consisting of attached wings acting as lever arms.

2) A non-motorized, drive-beltless, and gearless apparatus for tightening or loosening screws comprising of less than 2.5 inches vertical from the screw head, when in use.
